(19) United States
(12) Patent Application Publication
(10) Pub. No.: US 2019/0039602 A1
(43) Pub. Date: Feb. 7, 2019

(54) CONTROL DEVICE

(71) Applicant: AISIN AW CO., LTD., Anjo-shi, Aichi-ken (JP)

(72) Inventors: Keiichirou KUSABE, Okazaki (JP); Kohei TSUDA, Nishio (JP); Tomohiro ONOUCHI, Anjo (JP)

(73) Assignee: AISIN AW CO., LTD., Anjo-shi, Aichi-ken (JP)

(21) Appl. No.: 15/759,059

(22) PCT Filed: Sep. 30, 2016
(86) PCT No.: PCT/JP2016/079169

§ 371 Date: Mar. 9, 2018

(30) Foreign Application Priority Data
Sep. 30, 2015 (JP) 2015-192916

(51) Int. Cl. B60W 20/40; B60W 10/02; B60W 10/06; B60W 10/08

(52) U.S. Cl. CPC B60W 20/40; B60W 10/02; B60W 2510/081; B60W 10/08; B60W 2710/10; B60W 10/06

(57) ABSTRACT

A control device for controlling a vehicle drive device, as a control target, including a transfer clutch device, a rotary electric machine, and a transmission device that includes a plurality of shift clutch devices of which states of engagement are controlled in a shifting operation, on a power transfer path connecting an internal combustion engine to a wheel, the control device including an electronic control unit.

### BACKGROUND

The present disclosure relates to a control device that controls a vehicle drive device as a control target.

A hybrid vehicle has become commercially practical, which employs a combination of an internal combustion engine with a rotary electric machine as a source of driving force for wheels. A device disclosed in JP 2007-131070 A has been known as an example of a vehicle drive device for use in such a hybrid vehicle. The vehicle drive device in JP 2007-131070 A includes a transfer clutch device [a first clutch CL1], a rotary electric machine [a motor/generator MG], and a transmission device [an automatic transmission AT] each disposed on a power transfer path connecting an internal combustion engine [an engine E] to wheels [left and right rear wheels RL, RR].

When it becomes necessary to cause the vehicle that is running in an EV mode to mode transition from the EV mode to an HEV mode, a control device for the vehicle drive device in JP 2007-131070 A performs internal combustion engine start control using a torque of the rotary electric machine, with the transfer clutch device brought into a slip engagement state. At this time, the control device reduces a shock incident to the start of the internal combustion engine, by bringing into the slip engagement state one [a second clutch CL2] of shift clutch devices of the transmission device.

Incidentally, a shifting operation of the transmission device is performed immediately after the start of the internal combustion engine in some cases. In such a case, for example, if the shifting operation is attempted to progress by torque control in a situation in which a torque of the internal combustion engine immediately after the start is unstable, a shift time becomes longer or a shock is caused on engagement of the shift clutch devices regarding the shifting operation, in some cases. In performing the shifting operation of the transmission device immediately after the start of the internal combustion engine, it is preferable to avoid the phenomenon described above and to make the shifting operation progress with good responsivity, without deteriorating a shift feel. With regard to such a problem, no recognition has been made in JP 2007-131070.

### SUMMARY

A technique has been required for enabling a shifting operation with a good shift feel while ensuring the responsivity in performing the shifting operation after a start of an internal combustion engine.

A control device according to the present disclosure is a control device for controlling a vehicle drive device, as a control target, including a transfer clutch device, a rotary electric machine, and a transmission device that includes a plurality of shift clutch devices of which states of engagement are controlled in a shifting operation, on a power transfer path connecting an internal combustion engine to a wheel, the control device comprising an electronic control unit that is configured to: perform internal combustion engine start control of starting the internal combustion engine by increasing a rotational speed of the internal combustion engine from a situation of transferring a torque of the rotary electric machine to the wheel with the transfer clutch device brought into a disengagement state to drive a vehicle, synchronize the rotational speed of the internal combustion engine with a rotational speed of the rotary electric machine and to bring the transfer clutch device into an engagement state, and in performing the shifting operation subsequent to the synchronization of the internal combustion engine with the rotary electric machine, to perform rotational speed control on the rotary electric machine to change the rotational speed of the rotary electric machine toward a post-shift synchronization rotational speed determined in accordance with a speed ratio of the transmission device and a rotational speed of the wheel after termination of the shifting operation.

With this configuration, in performing the shifting operation subsequent to the synchronization of the internal combustion engine with the rotary electric machine, the electronic control unit performs the rotational speed control on the rotary electric machine with the transfer clutch device brought into the engagement state to change the rotational speed of the rotary electric machine toward the post-shift synchronization rotational speed. The electronic control unit therefore enables the progress of the shifting operation with good responsivity. At this time, the electronic control unit performs the rotational speed control on the rotary electric machine to change input rotation to the transmission device to a value around the post-shift synchronization rotational speed. The electronic control unit therefore enables accurate control on a change in input rotation to the transmission device over the entire shifting operation, without depending on fluctuation in torque to be input to the transmission device. For example, even in a case where an unstable output torque from the internal combustion engine immediately after the start of the internal combustion engine is input to the transmission device, the electronic control unit performs the rotational speed control on the rotary electric machine to accurately control the change in input rotation to the transmission device, thereby improving a shift feel. It is accordingly possible to perform a shifting operation with a good shift feel while ensuring the responsivity in performing the shifting operation after the start of the internal combustion engine.

Additional features and advantages of the technique according to the present disclosure will become more apparent from illustrative and non-limiting embodiments to be described below with reference to the drawings.

### BRIEF DESCRIPTION OF THE DRAWINGS

FIG. 1 is a schematic diagram of a vehicle drive device according to an embodiment.

FIG. 2 is a diagrammatic illustration of an internal configuration of a transmission device.

FIG. 3 is an operating chart illustrating states of engagement in the transmission device.

FIG. 4 is a block diagram illustrating a schematic configuration of a control device.

FIG. 5 is a flowchart illustrating processing procedures of control in starting an internal combustion engine.

FIG. 6 is a flowchart illustrating processing procedures of internal combustion engine start control.

FIG. 7 is a flowchart illustrating processing procedures of start direct shift control.

FIG. 8 is a timing chart illustrating an example of the control in starting the internal combustion engine.

FIG. 9 is a timing chart illustrating a comparative example of the control in starting the internal combustion engine.

FIG. 10 is a schematic diagram of a vehicle drive device according to another embodiment.

FIG. 11 is a schematic diagram of a vehicle drive device according to still another embodiment.

### DETAILED DESCRIPTION OF EMBODIMENTS

An embodiment of a control device will be described below. This control device 1 is a vehicle drive device control device that controls a vehicle drive device 3 as a control target. The vehicle drive device 3 to be controlled as a control target by the control device 1 is a drive device (a hybrid vehicle drive device) that drives a vehicle (a hybrid vehicle) equipped with an internal combustion engine EG and a rotary electric machine 33 each serving as a source of driving force for wheels W. The vehicle drive device 3 is constituted as a parallel hybrid vehicle drive device that drives a hybrid vehicle of a parallel type.

In the following description, a term “drivingly coupled” means a situation in which two rotating elements are coupled to each other such that driving force (synonymous with torque) is transferable therebetween. This concept includes a situation in which two rotating elements are coupled to each other so as to rotate together with each other and a situation in which two rotating elements are coupled to each other such that driving force is transferable therebetween via at least one transmission member. Examples of such a transmission member include various members (e.g., a shaft, a gear mechanism, a belt) that transfer rotation at a fixed rotational speed or while changing a rotational speed, and may include clutch devices (e.g., a friction clutch device, a meshing clutch device) that selectively transfer rotation and driving force.

The term “rotary electric machine” is used as a concept including all of a motor (an electric motor), a generator (an electric generator), and a motor-generator that functions as a motor and a generator as necessary.

In addition, with regard to a state of engagement of a friction clutch device, a term “engagement state” means a state in which a transfer torque capacity is generated at the friction clutch device. As used herein, the transfer torque capacity refers to a maximum torque that is transferable by friction by the friction clutch device. The magnitude of the transfer torque capacity is determined in proportion to a pressure (an engagement pressure) at which two clutch members (an input-side clutch member, an output-side clutch member) of the friction clutch device are mutually pressed against each other. The term “engagement state” includes a “direct engagement state” in which there is no rotational speed difference (slip) between the clutch members and a “slip engagement state” in which there is a rotational speed difference between the clutch members. A term “disengagement state” means a state in which no transfer torque capacity is generated at the friction clutch device.

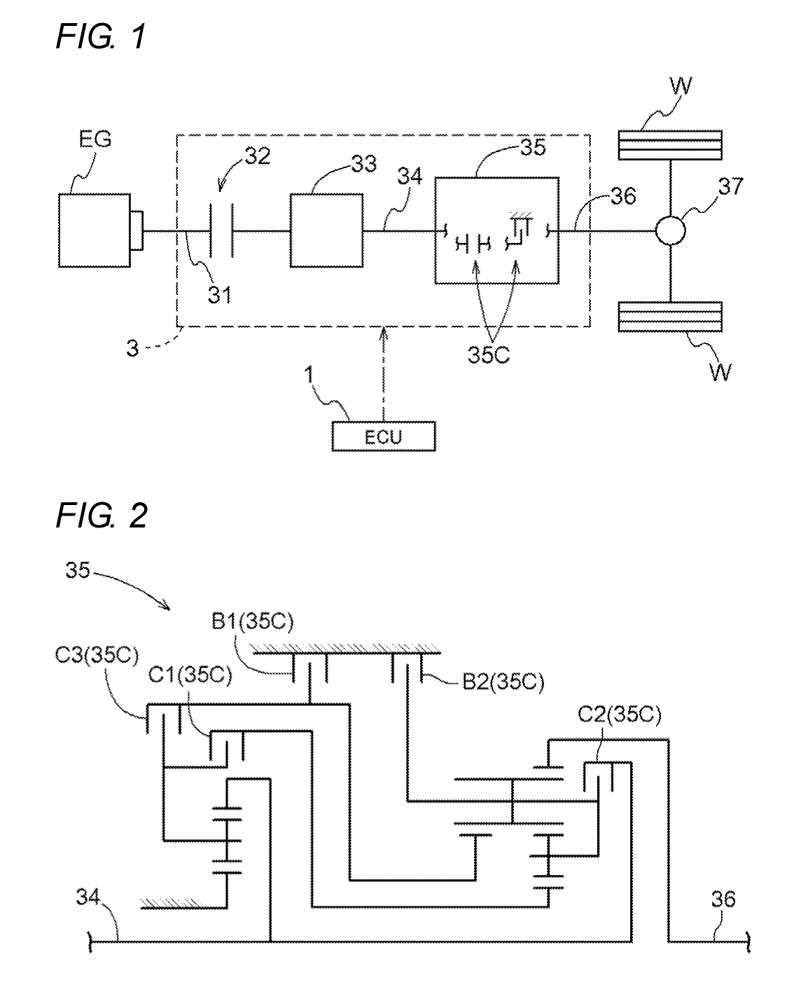

As illustrated in FIG. 1, the vehicle drive device 3 includes a transfer clutch device 32, the rotary electric machine 33, and a transmission device 35 each disposed on a power transfer path connecting the internal combustion engine EG to the wheels W. The vehicle drive device 3 also includes an input member 31, a shift input member 34, and an output member 36 in order to transfer rotation and driving force between the constituents on the power transfer path. The input member 31, the transfer clutch device 32, the rotary electric machine 33, the shift input member 34, the transmission device 35, and the output member 36 are arranged in the described order from the internal combustion engine EG side on the power transfer path.

The input member 31 is drivingly coupled to the internal combustion engine EG. The internal combustion engine EG is a prime mover (e.g., a gasoline engine, a diesel engine) that is driven by fuel combustion inside the engine to output motive power. The input member 31 is constituted of, for example, a shaft member (an input shaft). The input member 31 is drivingly coupled to an internal combustion engine output member (e.g., a crankshaft) that is an output member of the internal combustion engine EG so as to rotate together with the internal combustion engine output member. Accordingly, a rotational speed of the input member 31 is equal to a rotational speed Ne of the internal combustion engine EG. It should be noted that the input member 31 and the internal combustion engine output member may be directly coupled to each other or may be coupled to each other via another member such as a damper. The input member 31 is drivingly coupled to the rotary electric machine 33 via the transfer clutch device 32.

The transfer clutch device 32 selectively couples the input member 31 to the rotary electric machine 33. In other words, the transfer clutch device 32 is provided to be capable of disengaging the coupling between the internal combustion engine EG and the rotary electric machine 33. The transfer clutch device 32 functions as an internal combustion engine disconnection clutch device to disconnect the internal combustion engine EG from the wheels W. In the present embodiment, the transfer clutch device 32 is a friction clutch device. Examples of the friction clutch device may include a wet multi-plate clutch and the like.

The rotary electric machine 33 includes a stator fixed to a casing that is a non-rotatable member, and a rotor rotatably supported on a radially inner side of the stator. The rotary electric machine 33 is connected to an electric power storage device via an inverter device. The rotary electric machine 33 receives electric power supplied from the electric power storage device to perform powering. Alternatively, the rotary electric machine 33 supplies, to the electric power storage device, electric power generated by, for example, a torque of the internal combustion engine EG or an inertial force of the vehicle. The electric power storage device stores the electric power thus generated. The rotor of the rotary electric machine 33 is coupled to the shift input member 34 so as to rotate together with the shift input member 34. Accordingly, a rotational speed Nin of the shift input member 34 is equal to a rotational speed of the rotary electric machine 33 (the rotor). The shift input member 34 is constituted of, for example, a shaft member (a shift input shaft). The shift input member 34 that rotates together with the rotor is drivingly coupled to the transmission device 35.

In the present embodiment, the transmission device 35 is constituted as a stepped automatic transmission device. As illustrated in FIG. 2, the transmission device 35 of the present embodiment includes a plurality of planetary gear mechanisms and a plurality of shift clutch devices 35C. In the present embodiment, the planetary gear mechanisms include a first planetary gear device of a single pinion type (or a double pinion type) and a second planetary gear device of a Ravigneaux type. The shift clutch devices 35C include a clutch C1, a clutch C2, a clutch C3, a brake B1, and a brake B2. In the present embodiment, each of the clutch C1, the clutch C2, the clutch C3, the brake B1, and the brake B2 constituting the shift clutch devices 35C is a friction clutch device. Examples of the friction clutch device may include a wet multi-plate clutch, a wet multi-plate brake, and the like. It should be noted that the shift clutch devices 35C may include at least one one-way clutch.

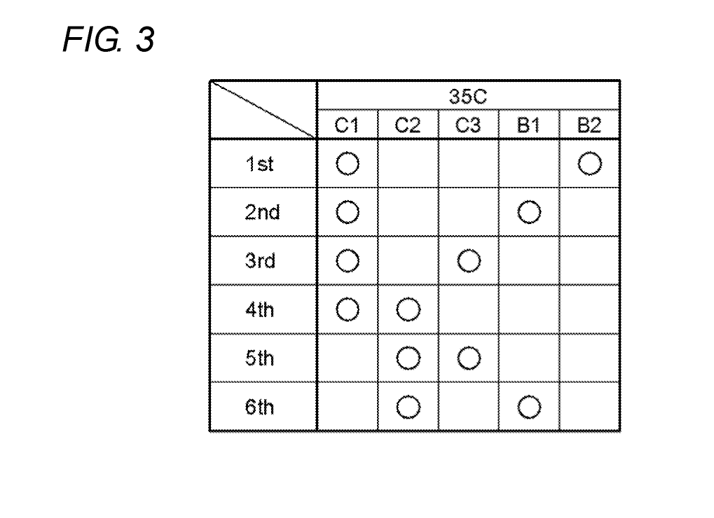

The transmission device 35 is capable of selectively establishing any of multiple shift speeds in accordance with a state of engagement of each of the clutch C1, the clutch C2, the clutch C3, the brake B1, and the brake B2, as illustrated in, for example, an operating chart of FIG. 3. For example, the transmission device 35 establishes the first shift speed (1st) with the first clutch C1 and the second brake B2 brought into the direct engagement state and with the remaining shift clutch devices 35C brought into the disengagement state. For example, the transmission device 35 also establishes the second shift speed (2nd) with the first clutch C1 and the first brake B1 brought into the direct engagement state and with the remaining shift clutch devices 35C brought into the disengagement state. The same things may hold true for the other shift speeds (3rd to 6th).

The transmission device 35 changes the rotational speed Nin of the shift input member 34, based on a speed ratio corresponding to the established shift speed, and transfers the changed rotational speed Nin to the output member 36. It should be noted that the term “speed ratio” refers to a ratio of the rotational speed Nin of the shift input member 34 to a rotational speed of the output member 36 and is calculated as a value obtained by dividing the rotational speed Nin of the shift input member 34 by the rotational speed of the output member 36. The output member 36 is constituted of, for example, a shaft member (an output shaft).

As illustrated in FIG. 1, the output member 36 is drivingly coupled to the right and left wheels W, provided in a pair, via a differential gear device 37. A torque transferred to the output member 36 is distributed and transferred to the two, right and left, wheels W via the differential gear device 37. The vehicle drive device 3 is thus capable of transferring one of, or each of, a torque of the internal combustion engine EG and a torque of the rotary electric machine 33 to the wheels W to drive the vehicle.

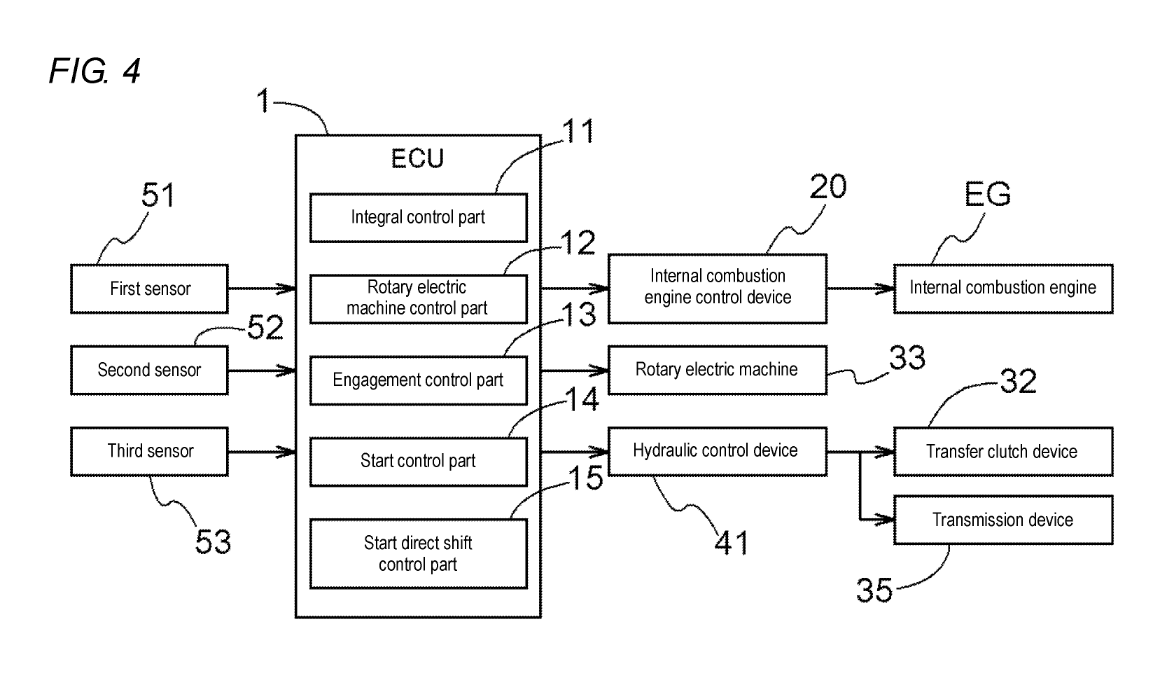

As illustrated in FIG. 4, the control device 1 that functions as a core performing operation control on each constituent of the vehicle drive device 3 includes an integral control part 11, a rotary electric machine control part 12, an engagement control part 13, a start control part 14, and a start direct shift control part 15. Each of these functional parts is constituted of software (a program) stored in a storage medium such as a memory, hardware such as an arithmetic circuit provided separately, or a combination of software with hardware. The functional parts are configured to be capable of exchanging information with one another. In addition, the control device 1 is configured to be capable of acquiring information on results of detection by various sensors (a first sensor 51, a second sensor 52, a third sensor 53) provided for the respective sections of the vehicle on which the vehicle drive device 3 is mounted.

The first sensor 51 detects a rotational speed of the input member 31 and a member (e.g., the internal combustion engine EG) that rotates together with the input member 31. The second sensor 52 detects a rotational speed of the shift input member 34 and a member (e.g., the rotary electric machine 33) that rotates together with the shift input member 34. The third sensor 53 detects a rotational speed of the output member 36 or a rotational speed of a member (e.g., the wheels W) that rotates synchronously with the output member 36. It should be noted that the term “rotate synchronously” means to rotate at a rotational speed proportional to a reference rotational speed. The control device 1 is capable of calculating a vehicle speed, based on a result of detection by the third sensor 53. In addition to the information described above, the control device 1 is configured to be capable of acquiring information such as an accelerator opening, a brake operation amount, and an amount of electric power stored in the electric power storage device.

The integral control part 11 performs control to integrate various kinds of control (e.g., torque control, rotational speed control, engagement control) to be performed on, for example, the internal combustion engine EG, the rotary electric machine 33, the transfer clutch device 32, and the transmission device 35 (the shift clutch devices 35C) as a whole of the vehicle. The integral control part 11 calculates a wheel required torque required for driving the vehicle (the wheels W), based on the sensor detected information (mainly, the information on the accelerator opening and the vehicle speed).

In addition, the integral control part 11 decides a drive mode, based on the sensor detected information (mainly, the information on the accelerator opening, the vehicle speed, and the amount of electric power stored in the electric power storage device). In the present embodiment, the drive mode selectable by the integral control part 11 includes an electric drive mode (hereinafter, referred to as an “EV mode”) and a hybrid drive mode (hereinafter, referred to as an “HEV mode”). The EV mode refers to a drive mode in which only a torque of the rotary electric machine 33 is transferred to the wheels W to drive the vehicle. The HEV mode refers to a drive mode in which a torque of the internal combustion engine EG and a torque of the rotary electric machine 33 are transferred to the wheels W to drive the vehicle.

The integral control part 11 decides an output torque (an internal combustion engine required torque) required of the internal combustion engine EG and an output torque (a rotary electric machine required torque) required of the rotary electric machine 33, based on the decided drive mode, the sensor detected information, and the like. The integral control part 11 decides, for example, a state of engagement of the transfer clutch device 32 and a target shift speed to be established by the transmission device 35, based on the decided drive mode, the sensor detected information, and the like.

In the present embodiment, the control device 1 (the integral control part 11) controls operating points (an output torque, a rotational speed) of the internal combustion engine EG via an internal combustion engine control device 20. The internal combustion engine control device 20 is capable of switching between torque control and rotational speed control to be performed on the internal combustion engine EG, in accordance with a running state of the vehicle. The torque control for the internal combustion engine EG refers to control of sending a command as to a target torque to the internal combustion engine EG and causing an output torque from the internal combustion engine EG to follow this target torque. The rotational speed control for the internal combustion engine EG refers to control of sending a command as to a target rotational speed to the internal combustion engine EG and deciding an output torque so as to cause the rotational speed Ne of the internal combustion engine EG to follow this target rotational speed.

The rotary electric machine control part 12 controls operating points (an output torque, a rotational speed) of the rotary electric machine 33. The rotary electric machine control part 12 is capable of switching between torque control and rotational speed control to be performed on the rotary electric machine 33, in accordance with a running state of the vehicle. The torque control for the rotary electric machine 33 refers to control of sending a command as to a target torque to the rotary electric machine 33 and causing an output torque from the rotary electric machine 33 to follow this target torque. The rotational speed control for the rotary electric machine 33 refers to control of sending a command as to a target rotational speed to the rotary electric machine 33 and deciding an output torque so as to cause a rotational speed of the rotary electric machine 33 to follow this target rotational speed.

The engagement control part 13 controls a state of engagement of the transfer clutch device 32, and a state of engagement of each shift clutch device 35C (C1, C2, C3, B1, B2) of the transmission device 35. In the present embodiment, the transfer clutch device 32 and the shift clutch devices 35C are hydraulically-driven friction clutch devices. The engagement control part 13 controls oil pressures to be supplied to the transfer clutch device 32 and each shift clutch device 35C, via a hydraulic control device 41, thereby controlling the state of engagement of the transfer clutch device 32 and the state of engagement of each shift clutch device 35C.

An engagement pressure of each clutch device changes in proportion to the magnitude of an oil pressure supplied to the corresponding clutch device. In accordance with this, the magnitude of a transfer torque capacity generated at each clutch device changes in proportion to the magnitude of an oil pressure to be supplied to the corresponding clutch device. The state of engagement of each clutch device is controlled to be set at any of the direct engagement state, the slip engagement state, and the disengagement state, in accordance with an oil pressure to be supplied. The hydraulic control device 41 includes a hydraulic control valve (e.g., a linear solenoid valve) that regulates an oil pressure of a hydraulic oil to be supplied from an oil pump (not illustrated). The oil pump may be, for example, a mechanical pump to be driven by the input member 31 or the shift input member 34, or may be, for example, an electric pump to be driven by a rotary electric machine for a pump. The hydraulic control device 41 regulates an opening of the hydraulic control valve in accordance with an oil pressure command from the engagement control part 13, thereby supplying to each clutch device a hydraulic oil with an oil pressure responsive to this oil pressure command.

The engagement control part 13 controls the state of engagement of the transfer clutch device 32 so as to set a drive mode decided by the integral control part 11. For example, the engagement control part 13 controls the transfer clutch device 32 so as to bring the transfer clutch device 32 into the disengagement state when the EV mode is set and controls the transfer clutch device 32 so as to bring the transfer clutch device 32 into the direct engagement state when the HEV mode is set.

In addition, the engagement control part 13 controls the state of engagement of each shift clutch device 35C (C1, C2, C3, B1, B2) so as to establish a target shift speed decided by the integral control part 11. The engagement control part 13 controls two of the shift clutch devices 35C in accordance with the target shift speed so as to bring the two shift clutch devices 35C into the direct engagement state and controls all the remaining shift clutch devices 35C so as to bring the remaining shift clutch devices 35C into the disengagement state (see FIG. 3). In a case where the target shift speed is changed during the running of the vehicle, the engagement control part 13 also controls a specific shift clutch device 35C so as to change the state of engagement of the shift clutch device 35C from the direct engagement state to the disengagement state and controls a different specific shift clutch device 35C so as to change the state of engagement of the shift clutch device 35C from the disengagement state to the engagement state, based on a difference between shift clutch devices 35C to be brought into the direct engagement state at the target shift speed before being changed and shift clutch devices 35C to be brought into the direct engagement state at the changed target shift speed.

In the following description, a shift clutch device 35C that is newly brought into the disengagement state during the shifting operation is referred to as a “disengagement-side clutch device 35R”, and a shift clutch device 35C that is newly brought into the engagement state (to be newly engaged) is referred to as an “engagement-side clutch device 35A”. In addition, a shift clutch device 35C that is brought into the direct engagement state at the target shift speed before being changed and the changed target shift speed in common and is maintained at the direct engagement state during the shifting operation is referred to as a “direct coupling-maintained clutch device 35S”. With reference to FIG. 3, for example, in performing a shifting operation from the second shift speed (2nd) to the first shift speed (1st), the first clutch C1 is a direct coupling-maintained clutch device 35S, the first brake B1 is a disengagement-side clutch device 35R, and the second brake B2 is an engagement-side clutch device 35A. For example, in performing a shifting operation from the second shift speed (2nd) to the third shift speed (3rd), the first clutch C1 is a direct coupling-maintained clutch device 35S, the first brake B1 is a disengagement-side clutch device 35R, and the third clutch C3 is an engagement-side clutch device 35A. The same things may hold true for the other shifting operations.

The present embodiment is specified so that the first clutch C1 is brought into the direct engagement state at each of the low shift speeds (1st to 4th). Therefore, there is a high possibility that the first clutch C1 becomes a direct coupling-maintained clutch device 35S on running in a low vehicle speed region. On the other hand, the present embodiment is also specified so that the second clutch C2 is brought into the direct engagement state at each of the high shift speeds (4th to 6th). Therefore, there is a high possibility that the second clutch C2 becomes a direct coupling-maintained clutch device 35S on running in a high vehicle speed region. As used herein, the term “low shift speed” refers to a shift speed of which a speed ratio becomes equal to or more than a reference speed ratio that is previously determined, and the term “high shift speed” refers to a shift speed of which a speed ratio becomes equal to or less than the reference speed ratio. The term “low vehicle speed region” refers to a vehicle speed region set to be less than a reference speed that is previously determined, and the term “high vehicle speed region” refers to a vehicle speed region set to be equal to or more than the reference speed.

In mode transition from the EV mode to the HEV mode, the start control part 14 performs internal combustion engine start control of starting the internal combustion engine EG. The vehicle is driven to run in the EV mode in such a manner that a torque of the rotary electric machine 33 is transferred to the wheels W with the transfer clutch device 32 brought into the disengagement state. In this situation, when a mode transition request to the HEV mode (an internal combustion engine start request) is issued because of, for example, an increase of a vehicle required torque or a reduction in an amount of electric power stored in the electric power storage device, the start control part 14 performs the internal combustion engine start control.

In the internal combustion engine start control, the start control part 14 brings one of the shift clutch devices 35C into the slip engagement state, in cooperation with the engagement control part 13. Herein, a shift clutch device 35C to be brought into the slip engagement state has a low possibility of becoming a direct coupling-maintained clutch device 35S (i.e., has a high possibility of becoming a disengagement-side clutch device 35R) on the assumption that the shifting operation is performed in the situation at the moment. This configuration has an advantage that when a shift request is issued during the performance of the internal combustion engine start control later, the progress of the shifting operation can be made quickly. In the present embodiment, the start control part 14 brings into the slip engagement state a shift clutch device 35C rather than a shift clutch device 35C (the first clutch C1, the second clutch C2) having a high possibility of becoming a direct coupling-maintained clutch device 35S, in accordance with a shift speed at the time when the internal combustion engine start control starts.

In the internal combustion engine start control, moreover, the start control part 14 performs rotational speed control on the rotary electric machine 33 to increase a rotational speed of the rotary electric machine 33, in cooperation with the rotary electric machine control part 12. For example, the start control part 14 performs the rotational speed control on the rotary electric machine 33 to increase the rotational speed of the rotary electric machine 33 to a rotational speed higher than a pre-shift synchronization rotational speed Nsb. Herein, the pre-shift synchronization rotational speed Nsb refers to a speed that is determined in accordance with a speed ratio of a shift speed before being changed (a speed ratio of the transmission device 35 before the shifting operation is performed) and a rotational speed of the output member 36 (or a rotational speed of the wheels W rotating synchronously with the output member 36). Specifically, the pre-shift synchronization rotational speed Nsb is calculated by multiplying the rotational speed of the output member 36 by the speed ratio of the shift speed before being changed. The start control part 14 sets a target rotational speed Nmt in the rotational speed control for the rotary electric machine 33 at a rotational speed higher by a first differential rotational speed ΔN1 than the pre-shift synchronization rotational speed Nsb to increase the rotational speed of the rotary electric machine 33 to a rotational speed higher than the pre-shift synchronization rotational speed Nsb. The first differential rotational speed ΔN1 is previously determined in consideration of a rotational speed difference that allows a disengagement-side clutch device 35R to be stably brought into the slip engagement state. For example, the first differential rotational speed ΔN1 may be appropriately set within a range from 100 to 300 [rpm]. In the present embodiment, the first differential rotational speed ΔN1 corresponds to a “slip differential rotational speed”.

In addition, in the internal combustion engine start control, the start control part 14 brings the transfer clutch device 32 into the slip engagement state, in cooperation with the engagement control part 13. The start control part 14 thus increases the rotational speed of the internal combustion engine EG, using a torque of the rotary electric machine 33, the torque being transferred from the rotary electric machine 33 side toward the internal combustion engine EG side via the transfer clutch device 32 in the slip engagement state. Thereafter, when the rotational speed Ne of the internal combustion engine EG becomes equal to or more than an ignitable rotational speed Nf that is previously determined, the start control part 14 starts spark ignition to start the internal combustion engine EG, in cooperation with the internal combustion engine control device 20. The ignitable rotational speed Nf is a rotational speed at which the internal combustion engine EG is capable of continuous self-sustaining, and is set at, for example, a rotational speed around an idle rotational speed. In the present embodiment, the internal combustion engine EG is started with a disengagement-side clutch device 35R brought into the slip engagement state. It is therefore possible to avoid torque fluctuation on initial combustion of the internal combustion engine EG from being transferred to the wheels W as it is. It is hence possible to reduce a shock to be caused in starting the internal combustion engine EG (a start shock).

When a shift request is issued during the performance of the internal combustion engine start control, the start direct shift control part 15 directly performs the shifting operation without waiting for the completion of the internal combustion engine start control. Herein, shift multiple transition from internal combustion engine start control has been conventionally performed. In the known shift multiple transition, after the synchronization of the internal combustion engine EG with the rotary electric machine 33, the progress of the shifting operation has been mainly made by at least one of torque control for the internal combustion engine EG and the rotary electric machine 33 and control for a transfer torque of an engagement-side clutch device 35A. In contrast to this, in shift multiple transition of the present embodiment, the start direct shift control part 15 continuously performs the rotational speed control on the rotary electric machine 33 even after the rotational speed of the internal combustion engine EG is synchronized with the rotational speed of the rotary electric machine 33 and the transfer clutch device 32 is brought into the direct engagement state. It should be noted that the shift multiple transition from the internal combustion engine start control will be referred to as “start direct shift control” below in some cases.

In cooperation with the rotary electric machine control part 12, then, the start direct shift control part 15 changes the target rotational speed Nmt of the rotary electric machine 33 toward a post-shift synchronization rotational speed Nsa, in accordance with the shifting operation, in the rotational speed control for the rotary electric machine 33 after the synchronization of the internal combustion engine EG with the rotary electric machine 33. Herein, the post-shift synchronization rotational speed Nsa refers to a speed that is determined in accordance with a speed ratio of a changed shift speed (a speed ratio of the transmission device 35 after termination of the shifting operation) and a rotational speed of the output member 36 (or a rotational speed of the wheels W rotating synchronously with the output member 36). Specifically, the post-shift synchronization rotational speed Nsa is calculated by multiplying the rotational speed of the output member 36 by the speed ratio of the changed shift speed. The start direct shift control part 15 continuously performs the rotational speed control on the rotary electric machine 33 to cause a disengagement-side clutch device 35R to be stably slipped for the purpose of reducing a start shock during the performance of the internal combustion engine start control, and makes the shifting operation progress by means of the rotational speed control for the rotary electric machine 33.

In the start direct shift control of the present embodiment, even after the transfer clutch device 32 is brought into the direct engagement state, the rotational speed control for the rotary electric machine 33 is continuously performed to change the rotational speed of the rotary electric machine 33 toward the post-shift synchronization rotational speed Nsa. It is therefore possible to make the shifting operation progress with good responsivity. At this time, the rotational speed Nin of the shift input member 34 is changed toward the post-shift synchronization rotational speed Nsa by the rotational speed control for the rotary electric machine 33. It is therefore possible to accurately control a change in rotation of the shift input member 34 without depending on fluctuation in torque to be input to the shift input member 34. For example, even in a case where an unstable output torque from the internal combustion engine EG immediately after the start of the internal combustion engine EG is input to the shift input member 34, a shift feel can be improved by accurately controlling the change in the rotation of the shift input member 34. It is accordingly possible to make the shifting operation progress with good responsivity and with a good shift feel in a case where a shift request is issued during the performance of the internal combustion engine start control.

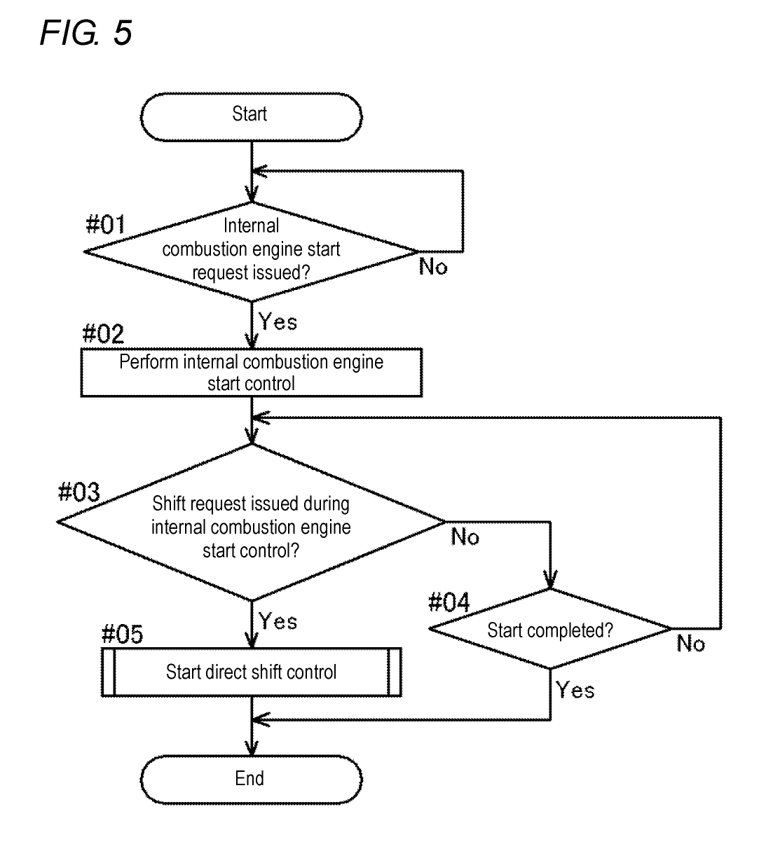

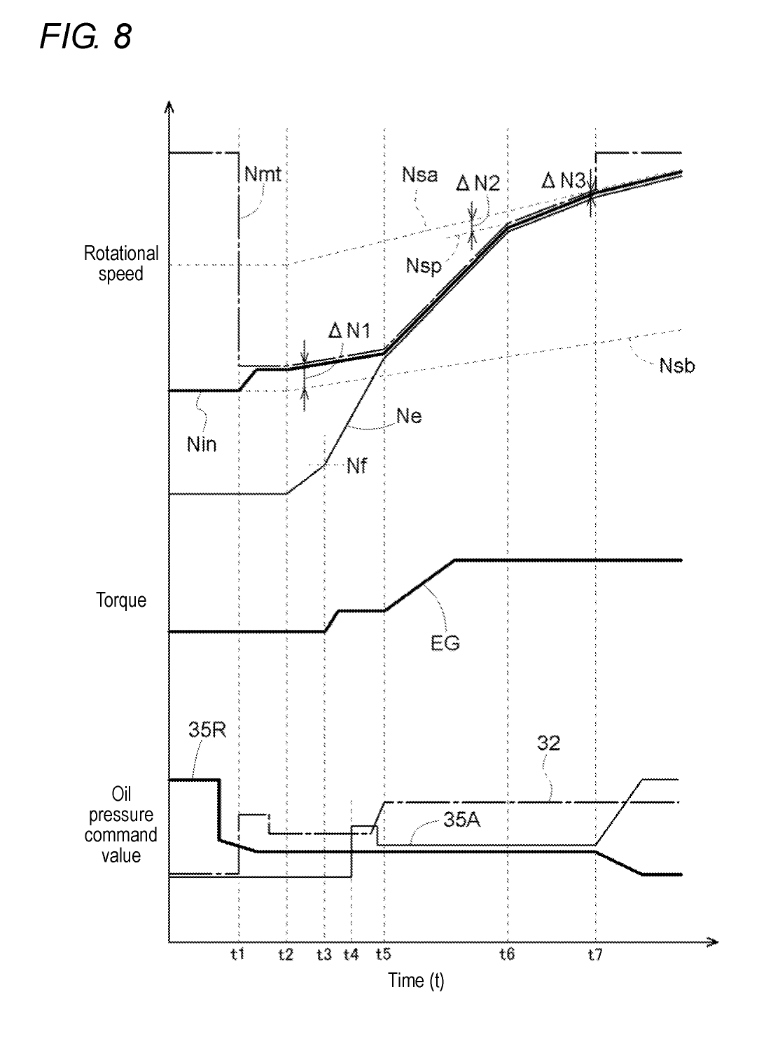

With reference to FIGS. 5 to 8, next, a description will be given of a specific example of control in starting the internal combustion engine, the control being performed by the start control part 14 and the start direct shift control part 15 as a core. It is assumed in the following example that the transfer clutch device 32 is brought into the disengagement state with the combustion of the internal combustion engine EG kept off, and the vehicle is driven to run in the EV mode. In FIG. 8, narrow broken lines respectively indicate the pre-shift synchronization rotational speed Nsb and the post-shift synchronization rotational speed Nsa.

With regard to the control in starting the internal combustion engine, as illustrated in FIG. 5, first, it is determined whether an internal combustion engine start request is issued (whether a target drive mode is changed to the HEV mode during the running of the vehicle in the EV mode) (step #01). When the internal combustion engine start request is issued (#01: Yes), the internal combustion engine start control is performed (#02).

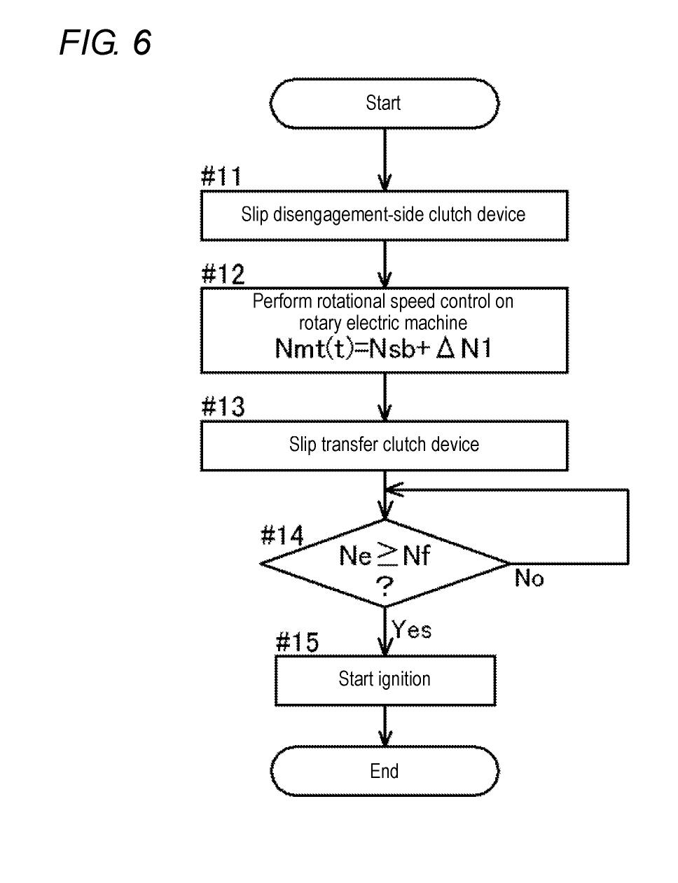

In the internal combustion engine start control, as illustrated in FIG. 6, a shift clutch device 35C rather than a shift clutch device 35C having a high possibility of becoming a direct coupling-maintained clutch device 35S is brought into the slip engagement state in accordance with a shift speed at this point in time. In other words, a shift clutch device 35C that becomes a disengagement-side clutch device 35R on the assumption that a shifting operation is performed to change a shift speed at this point in time to a shift speed adjacent to the shift speed is brought into the slip engagement state (#11/time t1). Next, the rotational speed control is performed on the rotary electric machine 33 with the disengagement-side clutch device 35R brought into the slip engagement state (#12). The target rotational speed Nmt in the rotational speed control for the rotary electric machine 33 is set at a rotational speed calculated by adding the first differential rotational speed ΔN1 to the pre-shift synchronization rotational speed Nsb (t1 to t5). Next, the transfer clutch device 32 is brought into the slip engagement state (#13/t2 to t5).

The rotational speed Ne of the internal combustion engine EG is gradually increased by a torque of the rotary electric machine 33, the torque being transferred from the rotary electric machine 33 side toward the internal combustion engine EG side via the transfer clutch device 32 in the slip engagement state (t2 to t3). Thereafter, when the rotational speed Ne of the internal combustion engine EG becomes equal to or more than the ignitable rotational speed Nf (#14: Yes/t3), spark ignition is started, so that the internal combustion engine EG starts to output a torque (#15).

It is determined whether a shift request is issued during the performance of the internal combustion engine start control (whether a target shift speed is changed during the performance of the internal combustion engine start control) (#03). When the internal combustion engine start control is completed before a shift request is issued (#03: No, #04: Yes), the control in starting the internal combustion engine is terminated.

On the other hand, when a shift request is issued during the performance of the internal combustion engine start control (#03: Yes/t4), the start direct shift control unique to the present embodiment is performed (#05). It is assumed in this example that the issued shift request concerns downshift of switching from a shift speed of which a speed ratio is relatively smaller to a shift speed of which a speed ratio is relatively larger.

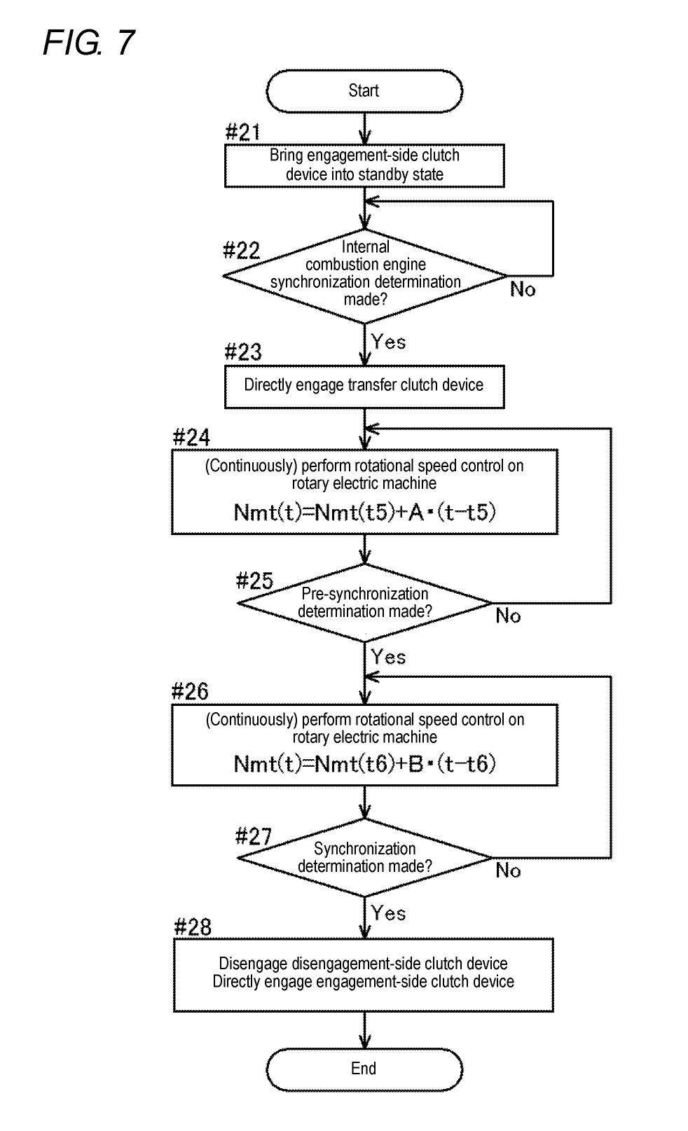

In the start direct shift control, as illustrated in FIG. 7, an oil pressure is supplied to an engagement-side clutch device 35A responsive to the changed shift speed, so that the engagement-side clutch device 35A is brought into a standby state that is a state immediately before a transfer torque is generated (#21). Next, an internal combustion engine synchronization determination is made (#22). This internal combustion engine synchronization determination is made to determine whether the rotational speed Ne, which gradually increases when the internal combustion engine EG starts self-sustaining, of the internal combustion engine EG is synchronized with the rotational speed of the rotary electric machine 33 (the rotational speed Nin of the shift input member 34). When it is determined that the internal combustion engine EG is synchronized with the rotary electric machine 33 (#22: Yes/t5), the transfer clutch device 32 is brought into the direct engagement state (#23). The rotational speed control for the rotary electric machine 33 is continuously performed even after the transfer clutch device 32 is brought into the direct engagement state, so that the progress of the shifting operation is made (#24). In the rotational speed control for the rotary electric machine 33 after the synchronization of the internal combustion engine EG with the rotary electric machine 33, the target rotational speed Nmt of the rotary electric machine 33 is set to increase at a first time rate of change A with, as an initial value, the target rotational speed Nmt at the time (t5) when the internal combustion engine EG is synchronized with the rotary electric machine 33. An actual rotational speed of the internal combustion engine EG and rotary electric machine 33 that rotate together with each other (an actual rotational speed Nin of the shift input member 34) responds to the increase in the target rotational speed Nmt to increase at a certain time rate of change (the first time rate of change A) toward the post-shift synchronization rotational speed Nsa.

In the present embodiment, a pre-synchronization determination is made in this situation (#25). This pre-synchronization determination is made to determine whether the rotational speed, which increases toward the post-shift synchronization rotational speed Nsa, of the internal combustion engine EG and rotary electric machine 33 (the rotational speed Nin of the shift input member 34) reaches a pre-synchronization specific rotational speed Nsp lower than the post-shift synchronization rotational speed Nsa. Herein, the pre-synchronization specific rotational speed Nsp is set at a rotational speed calculated by subtracting a second differential rotational speed ΔN2 from the post-shift synchronization rotational speed Nsa, for example. The second differential rotational speed ΔN2 is previously determined in consideration of a rotational speed difference that two rotatable members cannot be regarded as rotating synchronously with each other, but can be regarded as gradually approaching the situation of rotating synchronously with each other. For example, the second differential rotational speed ΔN2 may be appropriately set within a range from 50 to 100 [rpm]. In the present embodiment, the second differential rotational speed ΔN2 corresponds to a “set differential rotational speed”.

When it is determined that the rotational speed of the internal combustion engine EG and rotary electric machine 33 reaches the pre-synchronization specific rotational speed Nsp (#25: Yes/t6), the target rotational speed Nmt of the rotary electric machine 33 is changed while the rotational speed control is continuously performed on the rotary electric machine 33 (#26). Specifically, in the rotational speed control for the rotary electric machine 33 after the rotational speed reaches the pre-synchronization specific rotational speed Nsp, the target rotational speed Nmt of the rotary electric machine 33 is set to increase at a second time rate of change B with, as an initial value, the target rotational speed Nmt at the time (t6) when the rotational speed reaches the pre-synchronization specific rotational speed Nsp. In the present embodiment, the second time rate of change B is set at a value smaller than the first time rate of change A (smaller with respect to an absolute value). The actual rotational speed of the internal combustion engine EG and rotary electric machine 33 that rotate together with each other (the actual rotational speed Nin of the shift input member 34) responds to the increase in the rotational speed to gently increase at a certain time rate of change (the second time rate of change B smaller than the first time rate of change A) toward the post-shift synchronization rotational speed Nsa.

In the present embodiment, a synchronization determination is made in this situation (#27). This synchronization determination is made to determine whether the rotational speed, which increases toward the post-shift synchronization rotational speed Nsa, of the internal combustion engine EG and rotary electric machine 33 (the rotational speed Nin of the shift input member 34) reaches a synchronization range that is determined for the post-shift synchronization rotational speed Nsa. Herein, the synchronization range refers to a rotational speed region that is not more than a third differential rotational speed ΔN3 previously determined for the post-shift synchronization rotational speed Nsa. In other words, the synchronization range is a rotational speed region that is equal to or more than a rotational speed lower by the third differential rotational speed ΔN3 than the post-shift synchronization rotational speed Nsa and is equal to or less than a rotational speed higher by the third differential rotational speed ΔN3 than the post-shift synchronization rotational speed Nsa. The third differential rotational speed ΔN3 is previously determined in consideration of a rotational speed difference that the rotational speed of the internal combustion engine EG and rotary electric machine 33 is equal to the post-shift synchronization rotational speed Nsa or can be regarded as being equal to the post-shift synchronization rotational speed Nsa. For example, the third differential rotational speed ΔN3 may be appropriately set within a range from 0 to 50 [rpm].

When it is determined that the rotational speed of the internal combustion engine EG and rotary electric machine 33 reaches the synchronization range of the post-shift synchronization rotational speed Nsa (#27: Yes/t7), a shifting operation terminating process is performed. In this shifting operation terminating process, the disengagement-side clutch device 35R brought into the slip engagement state is brought into the disengagement state and the engagement-side clutch device 35A brought into the standby state is brought into the direct engagement state, so that the shifting operation is terminated (#28).

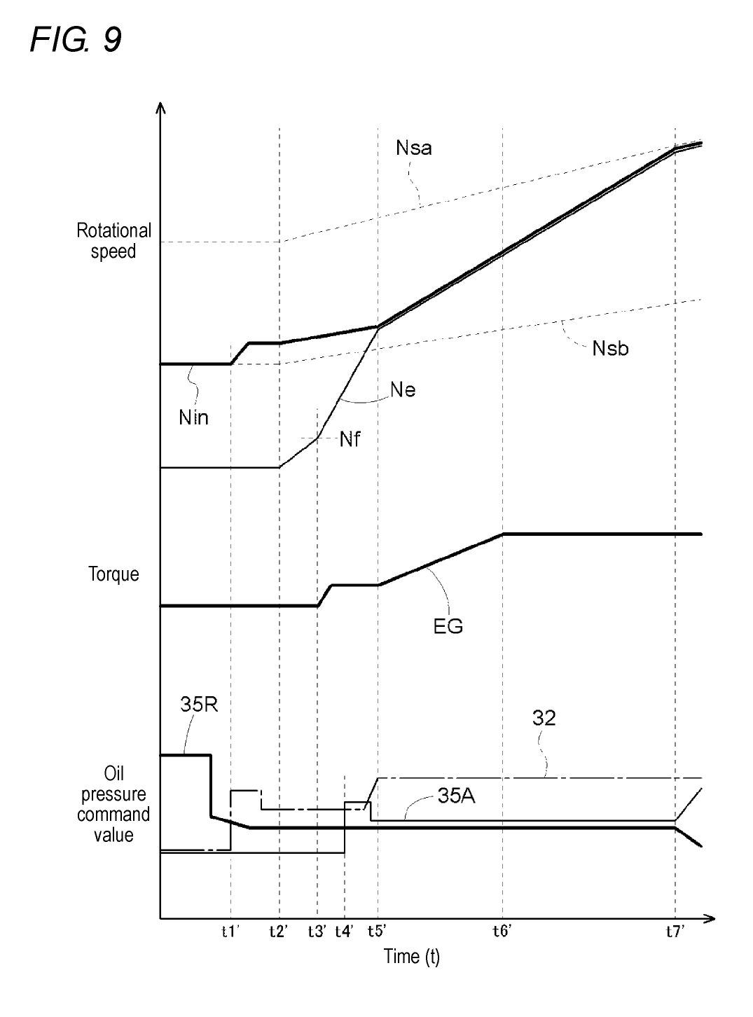

FIG. 9 illustrates a timing chart in a case of, unlike the present embodiment, performing shift control in the torque control for the internal combustion engine EG without continuously performing the rotational speed control for the rotary electric machine 33, in the start direct shift control. It is assumed in this example that the rising of the torque of the internal combustion engine EG is delayed immediately after the start of the internal combustion engine EG. In such a case, the shifting operation (downshift in this example) is performed slowly owing to the delay in the rising of the torque of the internal combustion engine EG, which results in an increase of a shift time. On the other hand, it is considered that an engagement-side clutch device 35A is engaged early in order to avoid the increase of the shift time. In such a case, however, there is a possibility that a shock (a shift end shock) may occur on the engagement of the engagement-side clutch device 35A. Consequently, it is difficult to achieve both the responsivity and the good shift feel in the shifting operation in the case of performing the shift control in the torque control.

In contrast to this, according to the start direct shift control of the present embodiment, the rotational speed control for the rotary electric machine 33 is continuously performed even after the synchronization of the internal combustion engine EG with the rotary electric machine 33. Therefore, it is possible to perform the shifting operation with a good shift feel while ensuring responsivity in the shifting operation. In other words, the rotational speed control for the rotary electric machine 33 is performed in the case of performing the shifting operation subsequent to the synchronization of the internal combustion engine EG with the rotary electric machine 33 (e.g., in the case of performing shift multiple transition from the internal combustion engine start control), so that both the responsivity and the good shift feel can be achieved in the shifting operation.

### Other Embodiments

(1) In the foregoing embodiment, the description has been given of, as an example, the configuration in which the target rotational speed Nmt is set at the rotational speed higher by the first differential rotational speed ΔN1 than the pre-shift synchronization rotational speed Nsb, in the rotational speed control for the rotary electric machine 33 before synchronization of the internal combustion engine EG with the rotary electric machine 33. However, the present disclosure is not limited to this configuration. For example, the target rotational speed Nmt may be set at a fixed rotational speed that is higher than the pre-shift synchronization rotational speed Nsb and does not change with time.

(2) In the foregoing embodiment, the description has been given of, as an example, the configuration in which, in the start direct shift control, the engagement-side clutch device 35A is brought into the standby state that is the state immediately before the transfer torque is generated, and the shifting operation is started after the transfer clutch device 32 is brought into the direct engagement state. However, the present disclosure is not limited to this configuration. For example, the engagement-side clutch device 35A is not brought into the standby state at the point in time when the shift request has been issued, and an oil pressure may be supplied to the engagement-side clutch device 35A for the first time after the transfer clutch device 32 is brought into the direct engagement state.

(3) In the foregoing embodiment, the description has been given of, as an example, the configuration in which the target rotational speed Nmt is changed in two steps toward the post-shift synchronization rotational speed Nsa in the rotational speed control for the rotary electric machine 33 after the synchronization of the internal combustion engine EG with the rotary electric machine 33. However, the present disclosure is not limited to this configuration. For example, the target rotational speed Nmt may be changed in one step toward the post-shift synchronization rotational speed Nsa or may be changed in at least three steps toward the post-shift synchronization rotational speed Nsa. Alternatively, the target rotational speed Nmt may be changed toward the post-shift synchronization rotational speed Nsa in a quadratic function manner, in a higher-order function manner, or in an exponential function manner.

(4) In the foregoing embodiment, the description has been given of, as an example, the configuration in which the pre-synchronization specific rotational speed Nsp used as a reference for the pre-synchronization determination is set to have the rotational speed difference closer by the second differential rotational speed ΔN2 to the pre-shift synchronization rotational speed Nsb with respect to the post-shift synchronization rotational speed Nsa. However, the present disclosure is not limited to this configuration. For example, the pre-synchronization specific rotational speed Nsp may be set to have a rotational speed difference closer by the second differential rotational speed ΔN2 to a side opposite from the pre-shift synchronization rotational speed Nsb with respect to the post-shift synchronization rotational speed Nsa. In this case, the rotational speed of the internal combustion engine EG and rotary electric machine 33 is changed to exceed the post-shift synchronization rotational speed Nsa once and then converge on the post-shift synchronization rotational speed Nsa.

(5) In the foregoing embodiment, the description has been given under the assumption that the shift request concerning downshift is issued during the performance of the internal combustion engine start control. However, the present disclosure is not limited to this configuration. For example, the technique according to the present disclosure may also be applicable even in a case where a shift request concerning upshift is issued during the performance of the internal combustion engine start control.

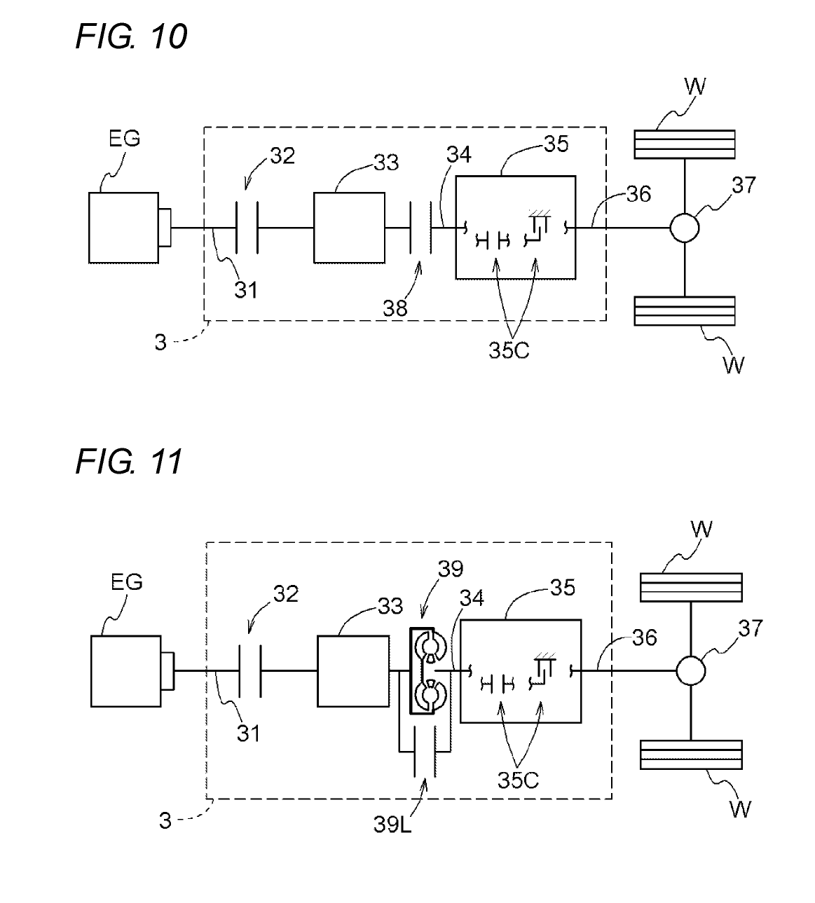

(6) In the foregoing embodiment, the description has been given of an example of the control target, that is, the vehicle drive device 3 in which only the transfer clutch device 32 (except for the shift clutch devices 35C) is provided as a clutch device to be disposed on the power transfer path connecting the internal combustion engine EG to the wheels W. However, the present disclosure is not limited to this configuration. In the vehicle drive device 3 as a control target, as illustrated in, for example, FIG. 10, a second transfer clutch device 38 may be additionally disposed on the power transfer path between the internal combustion engine EG and the transmission device 35. Alternatively, as illustrated in, for example, FIG. 11, a hydraulic coupling 39 (e.g., a torque converter, a fluid coupling) having a direct-coupling clutch device 39L may be additionally disposed on the power transfer path between the internal combustion engine EG and the transmission device 35.

(7) In the foregoing embodiment, the description has been given of, as an example, the configuration in which the internal combustion engine start control is performed through the use of the rotary electric machine 33 disposed on the power transfer path connecting the internal combustion engine EG to the wheels W. However, the present disclosure is not limited to this configuration. For example, a starter motor dedicated to start the internal combustion engine EG may be provided to perform the internal combustion engine start control. In this case, when a shift request is issued during the start of the internal combustion engine EG by the starter motor, after the start of the internal combustion engine EG, the transfer clutch device 32 is brought into the direct engagement state after the synchronization of the internal combustion engine EG with the rotary electric machine 33, and the progress of the shifting operation is made by the rotational speed control for the rotary electric machine 33, subsequent to the synchronization of the internal combustion engine EG with the rotary electric machine 33. Also with this configuration, it is possible to achieve both the responsivity and the good shift feel in the shifting operation.

(8) In the foregoing embodiment, the description has been given of, as an example, the configuration in which any two of the shift clutch devices 35C are brought into the direct engagement state to establish a target shift speed. However, the present disclosure is not limited to this configuration. For example, one shift clutch device 35C or at least three shift clutch devices 35C may be brought into the direct engagement state to establish a target shift speed.

(9) In the foregoing embodiment, the description has been given of an example of the control target, that is, the vehicle drive device 3 including, as the transmission device 35, the stepped automatic transmission device of the type provided with the plurality of planetary gear mechanisms and the plurality of shift clutch devices 35C (the stepped automatic transmission device of which the number of shift speeds is six in the example illustrated in FIG. 2). However, the present disclosure is not limited to this configuration. The vehicle drive device 3 as a control target may include, as the transmission device 35, a stepped automatic transmission device of which the number of shift speeds is two to five or a stepped automatic transmission device of which the number of shift speeds is seven or more. Alternatively, the vehicle drive device 3 may include, as the transmission device 35, a stepped automatic transmission device of another type, such as a dual clutch transmission (DCT).

It should be noted that the configuration disclosed in each of the foregoing embodiments (including the foregoing embodiments and other embodiments; the same applies to the following description) may be applied in combination with a configuration disclosed in any other embodiment unless any contradiction occurs.

Regarding other configurations as well, it should be understood that the embodiments disclosed in the specification are merely by way of example in all aspects. Accordingly, those skilled in the art can appropriately make various modifications without departing from the spirit of the present disclosure.

### Outline of Embodiments

To summarize the above, a control device according to the present disclosure preferably includes the following configurations.

A control device (1) for controlling a vehicle drive device (3), as a control target, including a transfer clutch device (32), a rotary electric machine (33), and a transmission device (35) that includes a plurality of shift clutch devices (35C) of which states of engagement are controlled in a shifting operation, on a power transfer path connecting an internal combustion engine (EG) to a wheel (W),

the control device (1) being configured to perform internal combustion engine start control of starting the internal combustion engine (EG) by increasing a rotational speed (Ne) of the internal combustion engine (EG) from a situation of transferring a torque of the rotary electric machine (33) to the wheel (W) with the transfer clutch device (32) brought into a disengagement state to drive a vehicle,

the control device (1) being configured to synchronize the rotational speed (Ne) of the internal combustion engine (EG) with a rotational speed of the rotary electric machine (33) and to bring the transfer clutch device (32) into an engagement state,

the control device (1) being configured, in performing the shifting operation subsequent to the synchronization, to perform rotational speed control on the rotary electric machine (33) to change the rotational speed (Nin) of the rotary electric machine (33) toward a post-shift synchronization rotational speed (Nsa) determined in accordance with a speed ratio of the transmission device (35) and a rotational speed of the wheel (W) after termination of the shifting operation.

With this configuration, in performing the shifting operation subsequent to the synchronization of the internal combustion engine with the rotary electric machine, the control device performs the rotational speed control on the rotary electric machine with the transfer clutch device brought into the engagement state to change the rotational speed of the rotary electric machine toward the post-shift synchronization rotational speed. The control device therefore enables the progress of the shifting operation with good responsivity. At this time, the control device performs the rotational speed control on the rotary electric machine to change input rotation to the transmission device to a value around the post-shift synchronization rotational speed. The control device therefore enables accurate control on a change in input rotation to the transmission device over the entire shifting operation, without depending on fluctuation in torque to be input to the transmission device. For example, even in a case where an unstable output torque from the internal combustion engine immediately after the start of the internal combustion engine is input to the transmission device, the control device performs the rotational speed control on the rotary electric machine to accurately control the change in input rotation to the transmission device, thereby improving a shift feel. It is accordingly possible to perform a shifting operation with a good shift feel while ensuring the responsivity in performing the shifting operation after the start of the internal combustion engine.

The control device (1) is configured, in the rotational speed control for the rotary electric machine (33) after the synchronization of the internal combustion engine (EG) with the rotary electric machine (33), to change the rotational speed (Nin) of the rotary electric machine (33) at a first time rate of change (A) toward a pre-synchronization specific rotational speed (Nsp) having a rotational speed difference by a set differential rotational speed (ΔN2) that is previously determined with respect to the post-shift synchronization rotational speed (Nsa) and then change the rotational speed (Nin) of the rotary electric machine (33) at a second time rate of change (B) smaller than the first time rate of change (A), toward the post-shift synchronization rotational speed (Nsa).

With this configuration, after the synchronization of the internal combustion engine with the rotary electric machine, the control device enables the change of the rotational speed of the internal combustion engine and rotary electric machine to the pre-synchronization specific rotational speed at a relatively early timing. In addition, after the rotational speed of the internal combustion engine and rotary electric machine reaches the pre-synchronization specific rotational speed, the control device enables the gentle change of the rotational speed of the internal combustion engine and rotary electric machine toward the post-shift synchronization rotational speed. It is accordingly possible to reduce a shift end shock while ensuring the quickness of the shifting operation.

The control device (1) is configured, in the internal combustion engine start control, to start the internal combustion engine (EG) by bringing one of the shift clutch devices (35C) into a slip engagement state, performing the rotational speed control on the rotary electric machine (33) to increase the rotational speed (Nin) of the rotary electric machine (33), bringing the transfer clutch device (32) into the slip engagement state to increase the rotational speed (Ne) of the internal combustion engine (EG).

With this configuration, the control device enables the start of the internal combustion engine through the use of the rotary electric machine disposed on the power transfer path connecting the internal combustion engine to the wheel, without the necessity of a dedicated starter motor. During the performance of the internal combustion engine start control, one of the shift clutch devices is brought into the slip engagement state. It is thus possible to reduce torque fluctuation at the start of the internal combustion engine to be transferred as it is to the wheel. It is hence possible to reduce a start shock. Moreover, it is possible to reduce the start shock through the use of one of the shift clutch devices of the transmission mechanism, without the necessity of a dedicated clutch device (a second transfer clutch device).

The control device (1) is configured, in the rotational speed control for the rotary electric machine (33) before synchronization of the internal combustion engine (EG) with the rotary electric machine (33), to change the rotational speed (Nin) of the rotary electric machine (33) to a rotational speed higher by a slip differential rotational speed (ΔN1) previously determined with respect to a pre-shift synchronization rotational speed (Nsb) determined in accordance with a speed ratio of the transmission device (35) and a rotational speed of the wheel (W) before starting the shifting operation.

With this configuration, the control device appropriately sets the magnitude of the slip differential rotational speed, thereby stably maintaining the slip engagement state of one of the shift clutch devices during the performance of the internal combustion engine start control. It is hence possible to reduce a start shock.

The shift clutch device (35C) brought into the slip engagement state during the performance of the internal combustion engine start control is a disengagement-side clutch device (35R) that is caused to transition from a direct engagement state to the disengagement state before and after the shifting operation; of the plurality of shift clutch devices (35C), a clutch device caused to transition from the disengagement state to the direct engagement state before and after the shifting operation is defined as an engagement-side clutch device (35A); and after the shift request is issued, to supply an oil pressure to the engagement-side clutch device (35A) to bring the engagement-side clutch device (35A) into a standby state that is a state immediately before a transfer torque is generated, and to bring the transfer clutch device (32) into the direct engagement state and then perform the shifting operation.

With this configuration, the control device causes the shift clutch device to slip in order to reduce a start shock and causes the disengagement-side clutch device to slip in association with the shifting operation, in common. It is therefore possible to make the shifting operation progress directly during the performance of the internal combustion engine start control. It is hence possible to make the shifting operation progress with good responsivity. The control device brings the engagement-side clutch device into the standby state that is a state immediately before a transfer torque is generated. Therefore, the control device allows the engagement-side clutch device to be brought into a state in which the engagement-side clutch device plays a role of torque transfer, immediately if a need arises later. Also from this respect, it is possible to enhance the responsivity of the shifting operation.

The control device (1) is configured to terminate the shifting operation after the rotational speed (Ne, Nin) of the internal combustion engine (EG) and rotary electric machine (33) reaches a rotational speed region that is not more than a determination differential rotational speed (ΔN3) previously determined with respect to the post-shift synchronization rotational speed (Nsa).

With this configuration, the control device enables the termination of the rotational speed control for the rotary electric machine at an appropriate timing during the performance of the shifting operation, based on the relationship between the rotational speed region determined based on the post-shift synchronization rotational speed and determination differential rotational speed and the rotational speed of the internal combustion engine and rotary electric machine. It is hence possible to appropriately drive the vehicle while satisfying required driving force by, for example, the torque control for at least one of the internal combustion engine and the rotary electric machine, the torque control being performed later.

A control device according to the present disclosure may be capable of producing at least one of the advantageous effects described above.

1. A control device for controlling a vehicle drive device, as a control target, including a transfer clutch device, a rotary electric machine, and a transmission device that includes a plurality of shift clutch devices of which states of engagement are controlled in a shifting operation, on a power transfer path connecting an internal combustion engine to a wheel, the control device comprising:
an electronic control unit that is configured to:
perform internal combustion engine start control of starting the internal combustion engine by increasing a rotational speed of the internal combustion engine from a situation of transferring a torque of the rotary electric machine to the wheel with the transfer clutch device brought into a disengagement state to drive a vehicle,
synchronize the rotational speed of the internal combustion engine with a rotational speed of the rotary electric machine and to bring the transfer clutch device into an engagement state, and
in performing the shifting operation subsequent to the synchronization, perform rotational speed control on the rotary electric machine to change the rotational speed of the rotary electric machine toward a post-shift synchronization rotational speed determined in accordance with a speed ratio of the transmission device and a rotational speed of the wheel after termination of the shifting operation.

2. The control device according to claim 1,
the electronic control unit being configured, in the rotational speed control for the rotary electric machine after the synchronization of the internal combustion engine with the rotary electric machine, to change the rotational speed of the rotary electric machine at a first time rate of change toward a pre-synchronization specific rotational speed having a rotational speed difference by a set differential rotational speed that is previously determined with respect to the post-shift synchronization rotational speed and then change the rotational speed of the rotary electric machine at a second time rate of change smaller than the first time rate of change, toward the post-shift synchronization rotational speed.

3. The control device according to claim 2,
the electronic control unit being configured, in the internal combustion engine start control, to start the internal combustion engine by bringing one of the shift clutch devices into a slip engagement state, performing the rotational speed control on the rotary electric machine to increase the rotational speed of the rotary electric machine, bringing the transfer clutch device into the slip engagement state to increase the rotational speed of the internal combustion engine.

4. The control device according to claim 3,
the electronic control unit being configured, in the rotational speed control for the rotary electric machine before synchronization of the internal combustion engine with the rotary electric machine, to change the rotational speed of the rotary electric machine to a rotational speed higher by a slip differential rotational speed previously determined with respect to a pre-shift synchronization rotational speed determined in accordance with a speed ratio of the transmission device and a rotational speed of the wheel before starting the shifting operation.

5. The control device according to claim 4,
the shift clutch device, which is brought into the slip engagement state during the performance of the internal combustion engine start control, being a disengagement-side clutch device that is caused to transition from a direct engagement state to the disengagement state before and after the shifting operation,
of the plurality of shift clutch devices, a clutch device, which is caused to transition from the disengagement state to the direct engagement state before and after the shifting operation, being defined as an engagement-side clutch device, and
the electronic control unit being configured, in performing the shifting operation, to supply an oil pressure to the engagement-side clutch device to bring the engagement-side clutch device into a standby state that is a state immediately before a transfer torque is generated, and to bring the transfer clutch device into the direct engagement state and then perform the shifting operation.

6. The control device according to claim 5,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

7. The control device according to claim 2,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

8. The control device according to claim 3,
the shift clutch device, which is brought into the slip engagement state during the performance of the internal combustion engine start control, being a disengagement-side clutch device that is caused to transition from a direct engagement state to the disengagement state before and after the shifting operation,
of the plurality of shift clutch devices, a clutch device, which is caused to transition from the disengagement state to the direct engagement state before and after the shifting operation, being defined as an engagement-side clutch device, and
the electronic control unit being configured, in performing the shifting operation, to supply an oil pressure to the engagement-side clutch device to bring the engagement-side clutch device into a standby state that is a state immediately before a transfer torque is generated, and to bring the transfer clutch device into the direct engagement state and then perform the shifting operation.

9. The control device according to claim 8,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

10. The control device according to claim 3,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

11. The control device according to claim 4,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

12. The control device according to claim 1,
the electronic control unit being configured, in the internal combustion engine start control, to start the internal combustion engine by bringing one of the shift clutch devices into a slip engagement state, performing the rotational speed control on the rotary electric machine to increase the rotational speed of the rotary electric machine, bringing the transfer clutch device into the slip engagement state to increase the rotational speed of the internal combustion engine.

13. The control device according to claim 12,
the shift clutch device, which is brought into the slip engagement state during the performance of the internal combustion engine start control, being a disengagement-side clutch device that is caused to transition from a direct engagement state to the disengagement state before and after the shifting operation,
of the plurality of shift clutch devices, a clutch device, which is caused to transition from the disengagement state to the direct engagement state before and after the shifting operation, being defined as an engagement-side clutch device, and
the electronic control unit being configured, in performing the shifting operation, to supply an oil pressure to the engagement-side clutch device to bring the engagement-side clutch device into a standby state that is a state immediately before a transfer torque is generated, and to bring the transfer clutch device into the direct engagement state and then perform the shifting operation.

14. The control device according to claim 13,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

15. The control device according to claim 12,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

16. The control device according to claim 12,
the electronic control unit being configured, in the rotational speed control for the rotary electric machine before synchronization of the internal combustion engine with the rotary electric machine, to change the rotational speed of the rotary electric machine to a rotational speed higher by a slip differential rotational speed previously determined with respect to a pre-shift synchronization rotational speed determined in accordance with a speed ratio of the transmission device and a rotational speed of the wheel before starting the shifting operation.

17. The control device according to claim 16,
the shift clutch device, which is brought into the slip engagement state during the performance of the internal combustion engine start control, being a disengagement-side clutch device that is caused to transition from a direct engagement state to the disengagement state before and after the shifting operation,
of the plurality of shift clutch devices, a clutch device, which is caused to transition from the disengagement state to the direct engagement state before and after the shifting operation, being defined as an engagement-side clutch device, and
the electronic control unit being configured, in performing the shifting operation, to supply an oil pressure to the engagement-side clutch device to bring the engagement-side clutch device into a standby state that is a state immediately before a transfer torque is generated, and to bring the transfer clutch device into the direct engagement state and then perform the shifting operation.

18. The control device according to claim 17,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

19. The control device according to claim 16,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.

20. The control device according to claim 1,
the electronic control unit being configured to terminate the shifting operation after the rotational speed of the internal combustion engine and rotary electric machine reaches a rotational speed region that is not more than a determination differential rotational speed previously determined with respect to the post-shift synchronization rotational speed.
